(19) United States
(12) Patent Application Publication
(10) Pub. No.: US 2013/0103784 A1
(43) Pub. Date: Apr. 25, 2013

(54) ROUTING CLIENT REQUESTS

(71) Applicant: Barrett Gibson Lyon, Pacifica, CA (US)

(72) Inventor: Barrett Gibson Lyon, Pacifica, CA (US)

(73) Assignee: 3CROWD TECHNOLOGIES, INC., San Mateo, CA (US)

(21) Appl. No.: 13/019,953

(22) Filed: Feb. 2, 2011

(51) Int. Cl. G06F 15/16

(52) U.S. Cl. 709/217

(57) ABSTRACT

A server configured to operate as either or both a web server and a DNS server is disclosed. Such a server responds to a received content request by either directly servicing the request or redirecting the request to another server capable of handling the request, and the server responds to a DNS request by at least partially resolving a domain name of the request and responding to the request with a DNS response.

### BACKGROUND OF THE INVENTION

DNS requests and content requests are conventionally handled by different servers. DNS requests are typically handled by dedicated name servers that are part of the Domain Name System. Content requests are typically handled by web servers that are capable of servicing the requests or redirecting the requests to other web servers. It would be useful to have a hybrid system to more intelligently route client requests.

### BRIEF DESCRIPTION OF THE DRAWINGS

Various embodiments of the invention are disclosed in the following detailed description and the accompanying drawings.

FIG. 1A is a high level block diagram illustrating an embodiment of a network environment comprising various components associated with servicing client requests.

FIG. 1B is a block diagram illustrating an embodiment of a manner in which a content request from a client is serviced.

FIG. 1C is a block diagram illustrating an embodiment of a manner in which a content request from a client is serviced.

FIG. 1D is a block diagram illustrating an embodiment of a request handling server.

FIG. 2 illustrates an embodiment of a process for servicing client requests.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

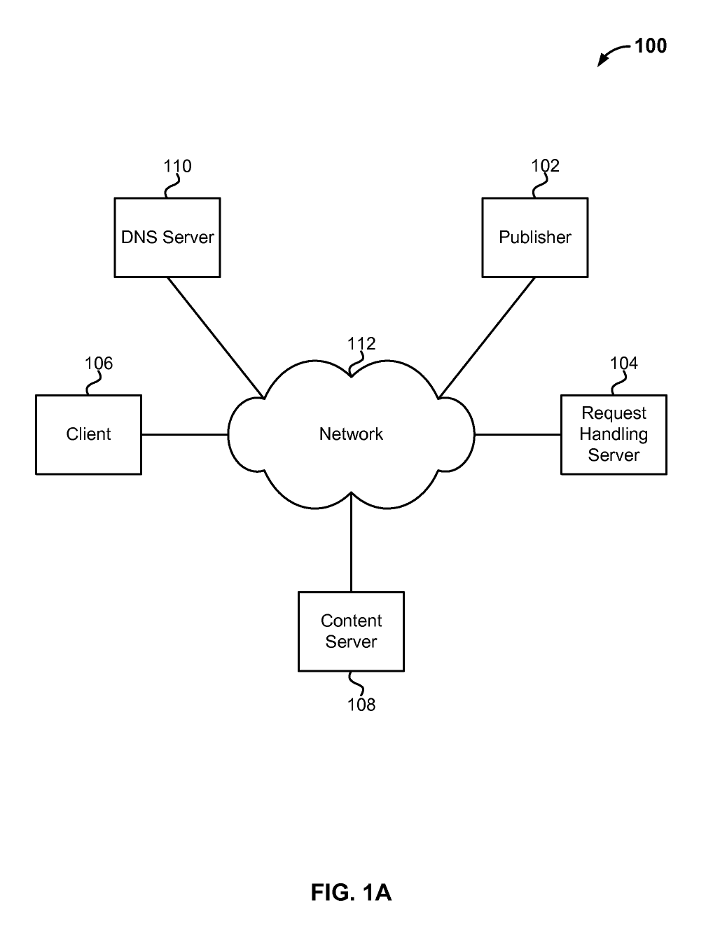

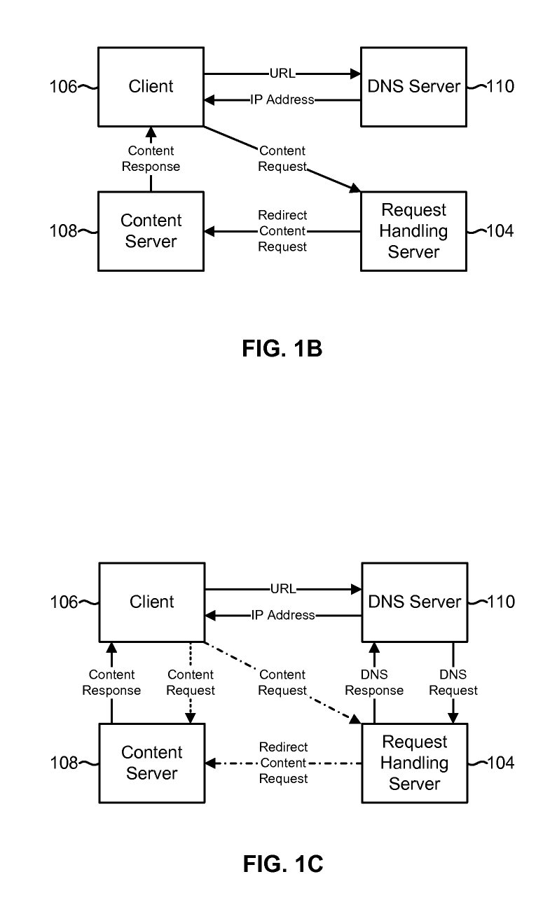

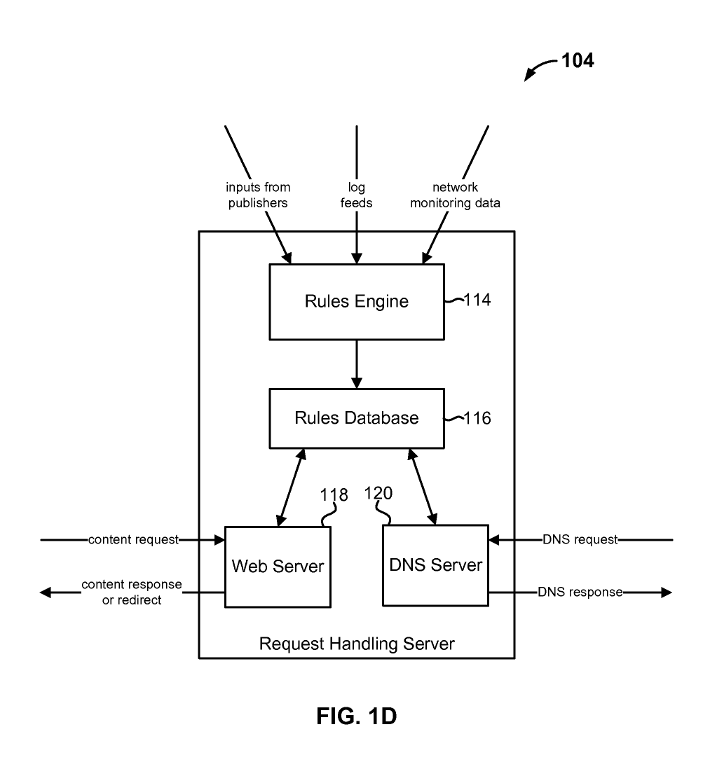

FIG. 1A is a high level block diagram illustrating an embodiment of a network environment 100 comprising various components associated with servicing client requests. Publisher 102 publishes one or more content items, for example, via one or more associated web pages and/or websites. Publisher 102 may employ a third party, such as a content delivery network (CDN), to host and/or service requests for content published by publisher 102. In some embodiments, a third party request handling server 104 facilitates the servicing of requests for content published by publisher 102 from clients, such as client 106, by directly servicing the requests or redirecting the requests to appropriate endpoints capable of servicing the requests, such as content server 108. DNS (Domain Name System) servers, such as DNS server 110, are employed by clients, such as client 106, to resolve desired URLs (Uniform Resource Locators) and connect to appropriate servers, such as request handling server 104. In some embodiments, as further described below, request handling server 104 is at least in part configured with DNS functionality that may be employed to more intelligently direct client requests for content via DNS, e.g., in accordance with a traffic management policy specified by the publisher 102 of the content.

The various components of FIG. 1A communicate via one or more private and/or public networks 112 (such as a LAN (Local Area Network), a WAN (Wide Area Network), the Internet, etc.) using any appropriate communication protocols (such as HTTP (Hypertext Transfer Protocol), SSL (Secure Sockets Layer), RTMP (Real Time Messaging Protocol), RTMP-E (Encrypted Real Time Messaging Protocol), RTMP over HTTP, torrent style protocols, DNS protocols, etc.). In some of the examples described herein, request handling server 104 is part of a third party entity employed by publisher 102 for managing requests from clients 106 for content published by publisher 102. In some cases, content server 108 may be a part of the third party entity of request handling server 104. In some cases, content server 108 may be a part of a different entity but may be a part of a network associated with and/or managed by the third party entity of request handling server 104. In some embodiments, publisher 102 employs a CDN for hosting and serving to clients 106 content published by publisher 102 that is a different third party entity than the third party entity of request handling server 104. In some such cases, content server 108 is a part of the CDN. In some embodiments, content server 108 comprises an origin of publisher 102. Although some affiliations of the various components comprising network environment 100 are described with respect to the provided examples, the techniques described herein may be employed with respect to any appropriate configuration in other embodiments. For example, in some embodiments, either or both of request handling server 104 and content server 108 may not be associated with one or more third party entities but may instead be a part of publisher 102. Although various components may be depicted as single blocks in the accompanying figures, in various embodiments, each block may comprise any number of interconnected physical and/or logical components. For instance, in some embodiments, request handling server 104 comprises a plurality of networked servers located in different geographical regions that, for example, share the same anycast IP (Internet Protocol) address.

In some embodiments, all or at least a subset of traffic associated with publisher 102 passes through request handling server 104, which manages the manner in which requests associated with publisher 102 are handled. In some embodiments, the third party entity associated with request handling server 104 provides a web-based interface via which publisher 102 can specify a policy by configuring one or more parameters, options, preferences, conditions, and/or rules for managing traffic associated with publisher 102. In some embodiments, publisher 102 may specify via such an interface the manner in which to resolve a domain name associated with publisher 102. In some embodiments, publisher 102 may specify or select an option to map an associated domain name to the domain name of request handling server 104, e.g., using a CNAME (canonical name) record in DNS, so that requests for content published by publisher 102 are directed using standard DNS techniques to request handling server 104. This configuration is described in further detail with respect to FIG. 1B. In some embodiments, publisher 102 may specify or select an option to employ request handling server 104 as a name server, e.g., using an NS record pointing to request handling server 104, for an associated domain name. In such cases, a standard DNS server 110 forwards a DNS request for the domain name from client 106 to the name server specified by the NS record, i.e., request handling server 104. Request handling server 104 is at least in part configured with DNS functionality and responds to the DNS request with an appropriate DNS response. Employing request handling server 104 as a name server gives request handling server 104 the benefit of having more control over client requests so that they can be more intelligently directed or routed. This configuration is described in further detail with respect to FIG. 1C. In some embodiments, publisher 102 may choose to map an associated domain name differently in different geographical regions. For example, a publisher 102 may map an associated domain name to request handling server 104 using a CNAME record in North America but an NS record in Europe.

FIG. 1B is a block diagram illustrating an embodiment of a manner in which a content request from a client 106 is serviced. In the example of FIG. 1B, the domain name of the publisher 102 of a requested content item comprises an alias of the domain name of request handling server 104. This relationship between the domain names of publisher 102 and request handling server 104 may be reflected in DNS, for example, via a CNAME record, and may be published into DNS by publisher 102 and/or the entity associated with request handling server 104, e.g., in response to receiving from publisher 102 a specification to employ standard DNS for at least a subset of traffic associated with publisher 102, including traffic associated with client 106. In FIG. 1B, client 106 requests DNS server 110 to resolve the domain name of a desired URL into an IP address. DNS server 110 may communicate with one or more other name servers in the Domain Name System to resolve the domain name. In the given example, resolving the domain name of publisher 102 in the URL into the IP address of request handling server 104 may include, for example, mapping the domain name of publisher 102 to the domain name of request handling server 104 as specified by a CNAME record and resolving the domain name of request handling server 104 into the IP address of request handling server 104, which may be performed by a root name server of the entity associated with request handling server 104. The IP address of request handling server 104 is returned by DNS server 110 to client 106, and client 106 subsequently connects directly to request handling server 104. Request handling server 104 receives a content request from client 106 and redirects the content request to a content server 108 capable of servicing the request. Any appropriate technique, such as an HTTP 302 or other redirect mechanism, may be employed to redirect the content request. Although a single redirect is depicted in FIG. 1B, the content request may undergo a plurality of redirects before being received by a content server 108 capable of servicing the request. The selection of a particular content server 108 to service the request may be based on a policy or ruleset specified by publisher 102 for managing its traffic. For example, a content server 108 that services the request at a least cost to publisher 102 may be selected. In some cases, content server 108 may comprise an origin of publisher 102 and/or may be a part of a CDN contracted by publisher 102. Content server 108 receives the content request via one or more redirects and services the request by responding to client 106 with the requested content. Although not depicted in the example of FIG. 1B, in some embodiments, redirection of the request to another server is not necessary in the cases in which request handling server 104 is capable of directly servicing the content request from client 106 with the requested content.

FIG. 1C is a block diagram illustrating an embodiment of a manner in which a content request from a client 106 is serviced. In the example of FIG. 1C, request handling server 104 also functions as a name server that is capable of at least partially resolving the domain name of publisher 102. This relationship between the domain name of publisher 102 and request handling server 104 may be reflected in DNS, for example, via an NS record, and may be published into DNS by publisher 102 and/or the entity associated with request handling server 104, e.g., in response to receiving from publisher 102 a specification to employ request handling server 104 as a name server to intelligently direct at least a subset of traffic associated with publisher 102, including traffic from client 106. In FIG. 1C, client 106 requests DNS server 110 to resolve the domain name of a desired URL into an IP address. DNS server 110 may communicate with one or more other name servers in the Domain Name System to resolve the domain name. In the example of FIG. 1C, DNS server 110 forwards the DNS request to a name server, i.e., request handling server 104, indicated by an NS record of the domain name of publisher 102. In this embodiment, request handling server 104 is configured to receive DNS requests for the domain name of publisher 102 and respond with an appropriate response. Request handling server 104 may respond with any type of response that is valid in DNS, and the type of response may be based on a policy or ruleset associated with managing traffic specified by publisher 102. Request handling server 104 may respond to a DNS request for the domain name of publisher 102, for example, with an IP address, a CNAME record, an NS record, etc. If request handling server 104 responds to a DNS request for the domain name of publisher 102 with an IP address, the IP address is provided as a response to the requesting client 106. If request handling server 104 responds to a DNS request for the domain name of publisher 102 with another type of DNS record, such as a CNAME record or an NS record, further DNS processing by one or more other DNS servers may be required to determine an IP address to provide as a response to client 106. Regardless of the type of DNS response provided by request handling server 104, an IP address is ultimately returned to client 106.

Employing request handling server 104 as a name server for at least partially resolving the domain name of publisher 102 provides the flexibility to dynamically select and/or change the type of DNS response provided for the domain name of publisher 102 based on one or more criteria and/or publisher preferences. In some embodiments, the type of DNS response selected by request handling server 104 for the domain name of publisher 102 may depend on the particular entity selected by request handling server 104 for receiving a content request from client 106, and such a selection may be based at least in part on a policy specified by publisher 102 for managing its traffic. For example, an entity that services a request at a least cost to publisher 102 may be selected, and an appropriate DNS response to direct client 106 to that entity may be selected. In some embodiments, the DNS response provided by request handling server 104 for the domain name of publisher 102 may comprise and/or eventually map into an IP address of a server that is capable of directly serving the content associated with the URL that is being resolved, such as content server 108. In some embodiments, the DNS response provided by request handling server 104 for the domain name of publisher 102 may comprise and/or eventually map into an IP address of a CDN of publisher 102. In some embodiments, the DNS response provided by request handling server 104 for the domain name of publisher 102 may comprise and/or eventually map into an IP address of request handling server 104, which may be configured to redirect a content request to an appropriate endpoint, e.g., content server 108, that is capable of servicing the request. In such cases, request handling server 104 functions as both a name server to at least partially resolve the domain name of publisher 102 as well as a web server configured to facilitate servicing of a client request for content published by publisher 102.

A content request from client 106 is directed to the IP address returned to client 106 by DNS server 110. In the cases in which the IP address corresponds to content server 108, a content request from client 106 is directly communicated to content server 108, as indicated by the dashed line in FIG. 1C. In some cases, such as when the IP address corresponds to a CDN of publisher 102, a content request from client 106 may undergo a series of one or more redirects before being received by a content server 108 capable of servicing the request. In the cases in which the IP address corresponds to request handling server 104, a content request from client 106 is received by request handling server 104 and may undergo one or more redirects before being received by content server 108, as indicated by the dashed-dotted lines in FIG. 1C. Content server 108 receives a content request from client 106 either directly or via one or more redirects and services the request by responding to client 106 with the requested content. Although not depicted in the example of FIG. 1C, in some embodiments, redirection of the request to another server is not necessary in the cases in which request handling server 104 is capable of directly servicing the request from client 106 with the requested content.

FIG. 1D is a block diagram illustrating an embodiment of request handling server 104. In some embodiments, request handling server 104 is part of a third party entity contracted by publisher 102 for managing traffic associated with publisher 102. As depicted, request handling server 104 includes a rules engine 114 that generates a ruleset that governs the manner in which traffic associated with a publisher 102 is managed or handled. Inputs to rules engine 114 are received from various sources such as via inputs from publishers, log feeds, monitored network data (such as average throughput, latency, time to first byte, etc., in a given geographical region), etc. Inputs may be received from a publisher 102 via a web-based interface provided by the entity associated with request handling server 104 for publisher 102 to configure the manner in which traffic associated with publisher 102 is to be managed. In some embodiments, rules engine 114 is at least in part configured or programmed by the entity associated with request handling server 104, for example, to implement a policy for managing the traffic of a publisher 102. For instance, an algorithm to identify a least cost option for servicing requests associated with a publisher 102 may be input into rules engine 114 that is based at least in part on one or more parameters specified by publisher 102, such as required QoS (Quality of Service), security specifications, cost constraints, geographical specifications, associated CDNs, etc. Based on various inputs, rules engine 114 generates a ruleset for each publisher 102 that comprises a set of one or more rules, each of which may be associated with a priority and/or an action. For instance, an example rule may specify that a content request associated with a publisher 102 that is received from geographic region X via ISP (Internet Service Provider) Y is to be directed to CDN Z. The ruleset for managing the traffic of a publisher 102 that is generated by rules engine 114 is stored in a rules database 116. In some embodiments, rules engine 114 and rules database 116 are dynamically updated as new inputs are received.

As depicted in FIG. 1D, request handling server 104 includes a web server 118 and a DNS server 120. In various embodiments, web server 118 and DNS server 120 may comprise different physical units or may be a part of the same physical unit. The operation of each of web server 118 and DNS server 120 is governed by the rulesets associated with various publishers that are stored in rules database 116. Web server 118 may communicate using any appropriate communication protocols and receives content requests associated with a publisher 102 from clients 106, e.g., via port 80. In various embodiments, web server 118 may comprise an HTTP or HTTPS (Hypertext Transfer Protocol Secure) server, an RTSP (Real Time Streaming Protocol) server, an RTMP (Real Time Messaging Protocol) server, etc. A content request received from a client 106 by web server 118 may be directly serviced by web server 118, e.g., if the requested content is available at request handling server 104, or may be redirected to another server that is capable of handling and/or servicing the request. The server selected to service the request may be determined from the ruleset of the associated publisher 102 stored in rules database 116.

DNS server 120 is configured to communicate with standard DNS protocols and/or messaging and receives DNS requests associated with a domain name of a publisher 102, e.g., via port 53. DNS server 120 may be configured in any appropriate manner such that it is able to receive and respond to DNS requests. In some embodiments, DNS server 120 comprises a name server of the Domain Name System. In some embodiments, DNS server 120 is different from a root name server associated with the entity of request handling server 104 that is configured to resolve the domain name of request handling server 104. In some embodiments, DNS server 120 comprises a DNS cache that is populated by a backend DNS server (not shown in the embodiment depicted in FIG. 1D) that implements a DNS policy for a domain name of a publisher 102 based on a ruleset associated with publisher 102 stored in rules database 116. A DNS request for the domain name of publisher 102 received by DNS server 120 is at least partially resolved by DNS server 120. DNS server 120 responds to the DNS request with an appropriate DNS response, such as an IP address, CNAME record, NS record, etc. The DNS response may be selected based on the ruleset of the associated publisher 102 stored in rules database 116. Consider again the aforementioned example of a rule that specifies that a content request associated with a publisher 102 that is received from geographic region X via ISP Y is to be directed to CDN Z. For such a rule, a DNS response from DNS server 120 for the domain name of publisher 102 may comprise a CNAME to CDN Z, which may then be resolved by one or more other DNS servers in the Domain Name System into an IP address of CDN Z, which is returned to a client 106 from which the DNS request was originally received.

In various embodiments, a publisher 102 may select to employ request handling server 104 as web/redirecting server 118, DNS server 120, or both. As described, publisher 102 may specify or select the desired services of request handling server 104 via a web-based interface. In some embodiments, publisher 102 may use such an interface to change the selected services, and such a change is dynamically communicated to rules engine 114 which in turn dynamically updates rules database 116. In some embodiments, publisher 102 may select an option to sample a service of request handling server 104, e.g., if it is not a primary service selected by publisher 102. For example, publisher 102 may select to employ the DNS service of request handling server 104 for most traffic associated with publisher 102 but employ the web/redirecting service of request handling server 104 once every thousand requests so that analytics of the traffic associated with publisher 102 can be compiled by request handling server 104. In such cases, publisher 102 may specify any desired sampling period. In some embodiments, publisher 102 may select to employ different services of request handling server 104 in different geographical regions. For example, publisher 102 may use the web/redirecting service in North America but the DNS service in Europe.

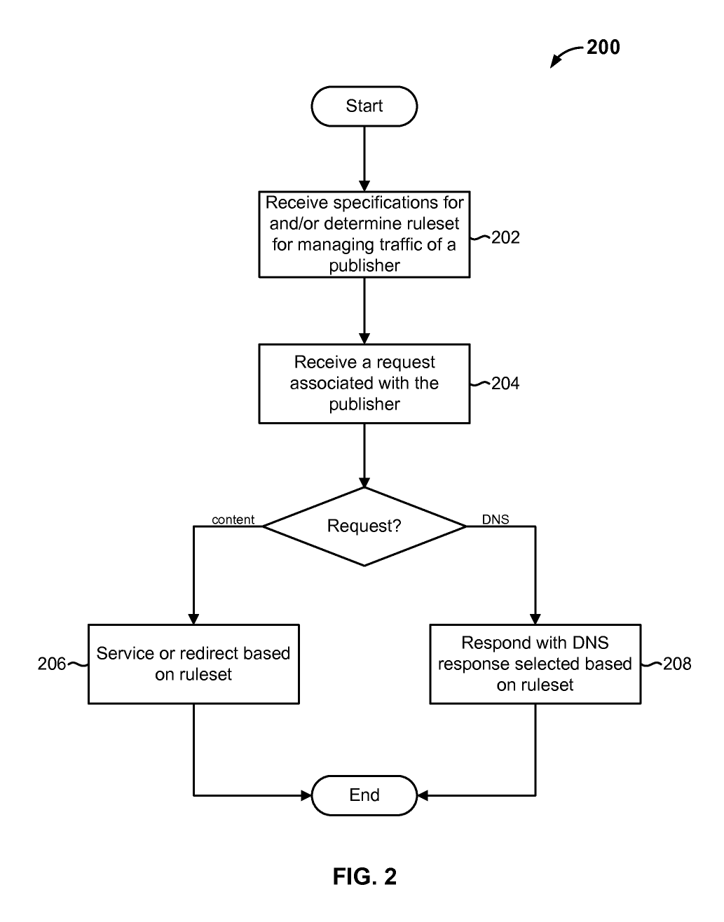

FIG. 2 illustrates an embodiment of a process 200 for servicing requests. In some embodiments, process 200 is employed by request handling server 104 of FIGS. 1A, 1C, and 1D. At 202, specifications for a ruleset for managing the traffic of a publisher are received, e.g., from the publisher and/or other input criteria, and/or determined. At 204, a request associated with the publisher is received. If the received request comprises a content request, the request is serviced or redirected to another server capable of handling and/or servicing the request based on the ruleset of the publisher at 206. Such a content request may be handled at 206, for example, by web/redirecting server 118 of request handling server 104. If the received request comprises a DNS request, the DNS request is responded to with a DNS response that is selected based on the ruleset of the publisher at 208. Such a DNS request may be handled at 208, for example, by DNS server 120 of request handling server 104. The DNS response may comprise any valid DNS response, such as an IP address, a CNAME record, an NS record, etc.

As described herein, a request handling server configured to function as both a web server and a DNS server may be employed to more intelligently route client requests based on a policy associated with a content publisher. The content publisher may select to employ either or both of the services provided by such a request handling server. The content publisher may select and easily switch between services via a web-based interface and may select different services for different segments of its traffic.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for responding to a request, comprising:
receiving a request at a server that is at least in part configured with DNS (Domain Name System) functionality;
in the event that the request comprises a content request, responding to the request by either directly servicing the request or redirecting the request to another server capable of handling the request; and
in the event that the request comprises a DNS request, at least partially resolving a domain name of the request and responding to the request with a DNS response.

2. The method recited in claim 1, wherein the server is configured to at least in part function as a name server of the Domain Name System.

3. The method recited in claim 1, wherein the domain name comprises a domain name of a content publisher.

4. The method recited in claim 1, wherein the DNS response comprises one or more of an IP (Internet Protocol) address, a canonical name (CNAME) record, and a name server (NS) record.

5. The method recited in claim 1, wherein the DNS response comprises or maps into an IP (Internet Protocol) address of a content server, a content delivery network (CDN), or the server that received the request.

6. The method recited in claim 1, wherein the request is associated with a content publisher.

7. The method recited in claim 6, wherein the server is employed by the content publisher as a web server, a DNS server, or both.

8. The method recited in claim 7, wherein a service provided by the server that is employed by the content publisher is selected by the content publisher via a web-based interface.

9. The method recited in claim 1, wherein the request is associated with a content publisher that has contracted the server to manage traffic of the content publisher based on a ruleset.

10. The method recited in claim 1, wherein the request is responded to based on a ruleset of a content publisher associated with the request.

11. The method recited in claim 1, wherein the server is configured to function as a DNS server for all but a subset of sampled requests associated with at least a segment of traffic of a content publisher and wherein the server is configured to function as a web server for the subset of sampled requests.

12. The method recited in claim 11, wherein a sampling period of the sampled requests is specified by the content publisher.

13. A system for responding to a request, comprising:
a processor configured to:
receive a request;
in the event that the request comprises a content request, respond to the request by either directly servicing the request or redirecting the request to a server capable of handling the request; and
in the event that the request comprises a DNS request, at least partially resolve a domain name of the request and respond to the request with a DNS response; and
is a memory coupled to the processor and configured to provide the processor with instructions.

14. The system recited in claim 13, wherein the DNS response comprises one or more of an IP (Internet Protocol) address, a canonical name (CNAME) record, and a name server (NS) record.

15. The system recited in claim 13, wherein the DNS response comprises or maps into an IP (Internet Protocol) address of a content server, a content delivery network (CDN), or the system that received the request.

16. The system recited in claim 13, wherein the request is responded to based on a ruleset of a content publisher associated with the request.

17. A computer program product for responding to a request, the computer program product being embodied in a computer readable storage medium and comprising computer instructions for:
receiving a request;
in the event that the request comprises a content request, responding to the request by either directly servicing the request or redirecting the request to a server capable of handling the request; and
in the event that the request comprises a DNS request, at least partially resolving a domain name of the request and responding to the request with a DNS response.

18. The computer program product recited in claim 17, wherein the DNS response comprises one or more of an IP (Internet Protocol) address, a canonical name (CNAME) record, and a name server (NS) record.

19. The computer program product recited in claim 17, wherein the DNS response comprises or maps into an IP (Internet Protocol) address of a content server, a content delivery network (CDN), or a server that received the request.

20. The computer program product recited in claim 17, wherein the request is responded to based on a ruleset of a content publisher associated with the request.
